(19) United States
(12) Patent Application Publication
(10) Pub. No.: US 2013/0063404 A1
(43) Pub. Date: Mar. 14, 2013

(54) Driver Circuitry for Displays

(71) Applicants: Abbas Jamshidi Roudbari, Sunnyvale, CA (US); Shih-Chang Chang, Cupertino, CA (US)

(72) Inventors: Abbas Jamshidi Roudbari, Sunnyvale, CA (US); Shih-Chang Chang, Cupertino, CA (US)

(21) Appl. No.: 13/231,841

(22) Filed: Sep. 13, 2011

(51) Int. Cl. G06F 3/038

(52) U.S. Cl. 345/204

(57) ABSTRACT

An electronic device display may have an array of display pixels. Each pixel may receive display data on a data line and may have a thin-film transistor that is controlled by a gate line signal on a gate line. The transistors may be controlled to apply electric fields across liquid crystal material. A common electrode may be used to distribute common electrode signals to the display pixels. The display may have a segmented common electrode with isolated regions that serve as respective touch sensor electrodes. A display may include a display driver integrated circuit that is adjusted to produce clock signals with desired rise and fall times. Gate driver circuitry such as thin-film transistor circuitry may include pass transistors controlled by latches. The pass transistors may be used in providing the clock signals with the adjusted rise and fall times to the gate lines to serve as gate line signals.

### BACKGROUND

This relates generally to electronic devices and, more particularly, to displays for electronic devices.

Electronic devices such as computers and cellular telephones are generally provided with displays. Displays such as liquid crystal displays contain a thin layer of liquid crystal material. Color liquid crystal displays include thin-film transistor layers and color filter layers. The layer of liquid crystal material in this type of display is interposed between the color filter layer and the thin-film transistor. Polarizer layers may be placed above and below the color filter layer, liquid crystal material, and thin-film transistor layer.

When it is desired to display an image for a user, display driver circuitry applies appropriate signals to a grid of data lines and gate lines within the thin-film transistor layer. These signals adjust electric fields associated with an array of pixels on the thin-film transistor layer. The electric field pattern that is produced controls the liquid crystal material and creates a visible image on the display.

During mass production, the structures that are used in forming liquid crystal displays are subject to manufacturing variations. Unless care is taken, these manufacturing variations may lead to visible artifacts on a display.

It would therefore be desirable to be able to provide improved techniques for forming electronic device displays.

### SUMMARY

Electronic devices may be provided with displays such as liquid crystal displays. A display may have an array of display pixels. The display pixels may be controlled using a grid of data lines and gate lines. Each pixel may receive display data on a data line and may have a thin-film transistor that is controlled by a gate line signal on a gate line. The thin-film transistors may be controlled to apply electric fields across a region of liquid crystal material.

A common electrode may be used to distribute common electrode signals to the display pixels. The display may have a segmented common electrode. The segmented common electrode may be divided into multiple isolated regions that serve as touch sensor electrodes. For example, the segmented common electrode may be divided into pads that are interconnected to form horizontal (row-shaped) capacitive sensor electrodes and vertical regions that serve as vertical (column-shaped) capacitive sensor electrodes.

The display may include a display driver integrated circuit that is adjusted to produce clock signals with desired rise and fall times. Clock signal adjustments may be made during display characterization operations as part of a manufacturing process. Gate driver circuitry such as polysilicon metal-oxide-semiconductor transistor circuitry may include pass transistors controlled by control signals supplied by latches. The pass transistors may be used in providing the clock signals with the rise and fall times that were adjusted by the display driver circuitry to the gate lines to serve as gate line signals for the display pixels. Rise and fall time adjustments to the clock signals and therefore the gate line signals may be made to ensure that visible artifacts such as artifacts associated with the segmented common electrode are not produced on the display, even when display components include manufacturing variations.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative electronic device with a display in accordance with an embodiment of the present invention.

FIG. 2 is a circuit diagram of data line demultiplexing circuitry for a display in accordance with an embodiment of the present invention.

FIG. 3 is a graph showing how data line demultiplexing circuitry of the type shown in FIG. 2 may be used in demultiplexing data line signals in accordance with an embodiment of the present invention.

FIG. 4 is a circuit diagram of an illustrative display pixel in a display in accordance with an embodiment of the present invention.

FIG. 5 is a graph showing how gate signal rise and fall times can affect signals on a common electrode of a display in accordance with an embodiment of the present invention.

FIG. 6 is a top view of an illustrative display with a segmented common electrode in accordance with an embodiment of the present invention.

FIG. 7 is a circuit diagram of illustrative gate driver circuitry in a display in accordance with an embodiment of the present invention.

FIG. 8 a circuit diagram of an illustrative latching circuit of the type that may be used in the gate driver circuitry of FIG. 7 in accordance with an embodiment of the present invention.

FIG. 9 is a graph showing signals involved in operating gate driver circuitry such as the gate driver circuitry of FIG. 7 in accordance with an embodiment of the present invention.

FIG. 10 is a graph showing how a display driver integrated circuit may produce a clock signal with adjustable rise and fall times in accordance with an embodiment of the present invention.

FIG. 11 is a system diagram showing how a display may be characterized and adjusted during manufacturing using test equipment in accordance with an embodiment of the present invention.

FIG. 12 is a flow chart of illustrative steps involved in characterizing display performance and making compensating adjustments to display settings such as gate driver rise and fall time settings during manufacturing in accordance with an embodiment of the present invention.

FIG. 13 is a circuit diagram of an illustrative low-crossbar-current latch of the type that may be used in the gate driver circuitry of FIG. 7 in accordance with an embodiment of the present invention.

### DETAILED DESCRIPTION

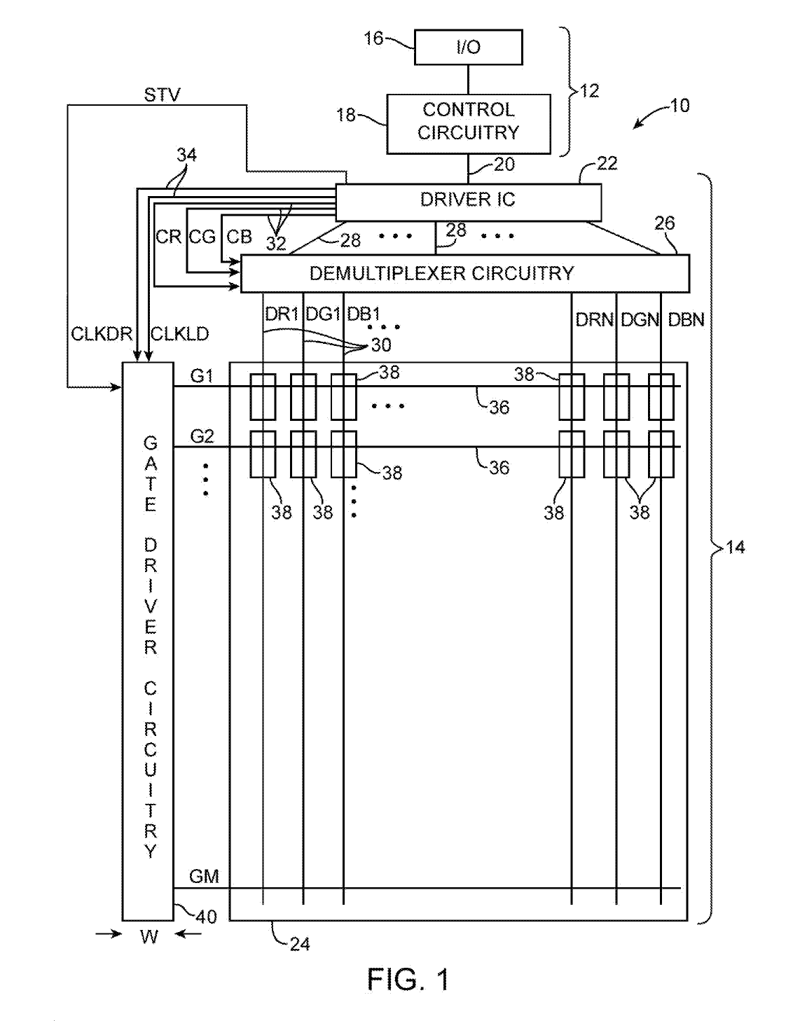

An illustrative electronic device of the type that may be provided with a display is shown in FIG. 1. Electronic device 10 may be a computer such as a computer that is integrated into a display such as a computer monitor, a laptop computer, a tablet computer, a somewhat smaller portable device such as a wrist-watch device, pendant device, or other wearable or miniature device, a cellular telephone, a media player, a tablet computer, a gaming device, a navigation device, a computer monitor, a television, or other electronic equipment.

As shown in FIG. 1, device 10 may include a display such as display 14. Display 14 may be a touch screen that incorporates capacitive touch electrodes or other touch sensor components or may be a display that is not touch sensitive. Display 14 may include image pixels formed from light-emitting diodes (LEDs), organic LEDs (OLEDs), plasma cells, electronic ink elements, liquid crystal display (LCD) components, or other suitable image pixel structures. Arrangements in which display 18 is formed using liquid crystal display pixels are sometimes described herein as an example. This is, however, merely illustrative. Any suitable type of display technology may be used in forming display 14 if desired.

Display 14 may be coupled to device components 12 such as input-output circuitry 16 and control circuitry 18. Input-output circuitry 16 may include components for receiving device input. For example, input-output circuitry 16 may include a microphone for receiving audio input, a keyboard, keypad, or other buttons or switches for receiving input (e.g., key press input or button press input from a user), sensors for gathering input such as an accelerometer, a compass, a light sensor, a proximity sensor, touch sensor (e.g., touch sensors associated with display 14 or separate touch sensors), or other input devices. Input-output circuitry 16 may also include components for supplying output. Output circuitry may include components such as speakers, light-emitting diodes or other light-emitting devices for producing light output, vibrators, and other components for supplying output. Input-output ports in circuitry 16 may be used for receiving analog and/or digital input signal and may be used for outputting analog and/or digital output signals. Examples of input-output ports that may be used in circuitry 16 include audio ports, digital data ports, ports associated with 30-pin connectors, and ports associated with Universal Serial Bus connectors and other digital data connectors.

Control circuitry 18 may be used in controlling the operation of device 10. Control circuitry 18 may include one or more integrated circuits. For example, control circuitry 18 may include storage circuits such as volatile and non-volatile memory circuits, solid state drives, hard drives, and other memory and storage circuitry. Control circuitry 18 may also include processing circuitry such as processing circuitry in a microprocessor or other processor. Examples of integrated circuits that may be included in control circuitry 18 include microprocessors, digital signal processors, power management units, baseband processors, microcontrollers, application-specific integrated circuits, circuits for handling audio and/or visual information, and other control circuitry.

Control circuitry 18 may be used in running software for device 10. For example, control circuitry 18 may be configured to execute code in connection with the displaying of images on display 14 (e.g., text, pictures, video, etc.), control circuitry 18 may be configured to run testing software (e.g., code that is used during manufacturing to support interactions between device 10 and test equipment), control circuitry 18 may be configured to run code that allows control circuitry 18 to adjust operating settings (e.g., to store calibration data or other settings in storage in control circuitry 18 such as non-volatile storage), etc.

Display 14 may include a pixel array such as pixel array 24. Pixel array 24 may be controlled using control signals produced by display driver circuitry such as display driver circuitry 22. Display driver circuitry 22 may be implemented using one or more integrated circuits (ICs) and may sometimes be referred to as a driver IC, display driver integrated circuit, or display driver. Display driver integrated circuit 22 may be mounted on an edge of a thin-film transistor layer in display 14 (as an example).

During operation of device 10, control circuitry 18 may provide data to display driver 22. For example, control circuitry 18 may use a path such as path 20 to supply display driver 22 with digital data corresponding to text, graphics, video, or other images to be displayed on display 14. Display driver 22 may convert the data that is received on path 20 into signals for controlling the pixels of pixel array 24.

Pixel array 24 may contain rows and columns of display pixels 38. The circuitry of pixel array 24 may be controlled using signals such as data line signals on data lines 30 and gate line signals on gate lines 36.

Pixels 38 in pixel array 24 may contain thin-film transistor circuitry (e.g., polysilicon transistor circuitry) and associated structures for producing electric fields across liquid crystal material in display 14. The thin-film transistor structures that are used in forming pixels 38 may be located on a substrate (sometimes referred to as a thin-film transistor layer). The thin-film transistor (TFT) layer may be formed from a planar glass substrate, a plastic substrate, or other suitable substrate.

Gate driver circuitry 40 may be used to generate gate signals G1 . . . GM on gate lines 36. Circuits such as gate driver circuitry 40 may also be formed from thin-film transistors on the thin-film transistor layer. Although only gate driver circuitry 40 on the left of pixel array 24 is shown in the example of FIG. 1, gate driver circuitry 40 may include gate driver circuits located along both the right and left edges of pixel array 40.

The data line signals in pixel array 24 carry analog image data (e.g., voltages with magnitudes representing pixel brightness levels). During the process of displaying images on display 14, display driver integrated circuit 22 may receive digital data from control circuitry 18 via path 20 and may produce corresponding analog data on paths 28. The analog data signals on path 28 may be demultiplexed by demultiplexer circuitry 26 in accordance with red control signal CR, green control signal CG, and blue control signal CB from driver circuitry 22 on lines 32. This demultiplexing process produces corresponding color-coded analog data line signals on data lines 30 such as data signals DR1 . . . DRN (for the red channel), DG1 . . . DGN (for the green channel), and DB1 . . . DBN (for the blue channel).

The data line signals on data lines 30 may be provided to N columns of display pixels 38 in pixel array 24. Gate line signals G1 . . . GM may be provided to M rows of pixels 38 in pixel array 24 by gate driver circuitry 40. Gate driver circuitry 40 may produce the gate signals G1 . . . GM based on clock signals received from display driver circuitry 22. Display driver circuitry 22 may provide clock signals to gate driver circuitry 40 on paths such as paths 34. For example, display driver circuitry 22 may produce a two-phase clock made up of a first clock phase (clock signal CLKDR) and a second clock phase (clock signal CLKLD). Gate driver circuitry 40 may use the clock signals from display driver circuitry 22 in producing gate signals G1 . . . GM.

The circuitry of display 14 such as demultiplexer circuitry 26 and gate driver circuitry 40 and the circuitry of pixels 38 may be formed from transistors that are fabricated on the thin-film transistor substrate layer of display 14. These transistor may be, for example, polysilicon thin-film transistors. It may be desirable to minimize the width W of gate driver circuitry 40 that is formed along one or more sides of display 14. For example, it may be desirable to minimize W to allow display 14 to be implemented with a thin border. The size of W may be minimized by minimizing circuit complexity (e.g., transistor count) in gate driver circuitry 40.

To accommodate manufacturing variations, display 14 may be provided with adjustable circuitry. For example, driver circuitry 22 and gate driver circuitry 40 may be used to produce gate signals with adjustable transition times (sometimes referred to as adjustable rise and fall times). The ability to adjust the rise and fall times of gate signals G1 . . . GM may allow a manufacturer to compensate display 14 for manufacturing variations, thereby ensuring that display 14 will satisfy desired performance criteria.

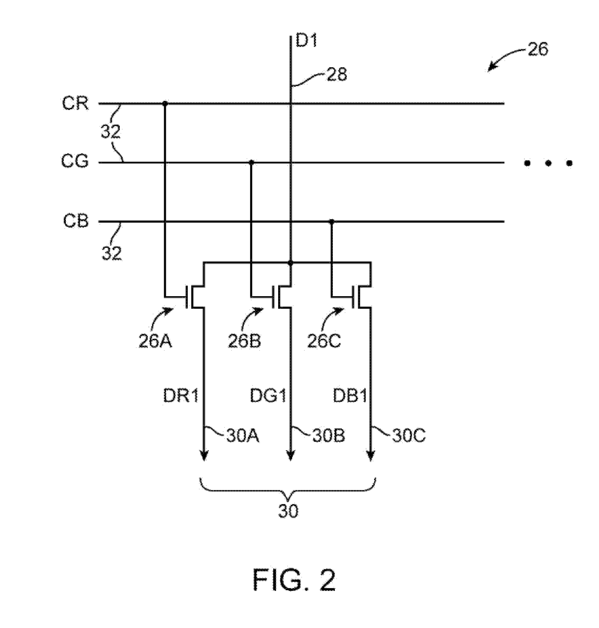

FIG. 2 is a circuit diagram of a portion of demultiplexer circuitry 26 showing how control signals such CR, CG, and CB on control lines 32 may be applied to the gates of respective transistors such as transistors 26A, 26B, and 26C. Display driver circuitry 22 may assert signals CR, CG, and CB on paths 32 in sequence. When signal CR is asserted, transistor 26A will be turned on and the current value of D1 on path 28 will be conveyed to path 30A as data signal DR1. When signal CG is asserted, transistor 26B will be turned on and the current value of D1 on path 28 will be conveyed to path 30B as data signal DG1. Data signal DB1 on path 30C may be produced when signal CB is asserted to turn on transistor 26C. The signals in FIG. 2 are associated with a first column of pixel array 24. Red, green, and blue data signals are similarly produced on data lines 30 for each of the other columns in pixel array 24.

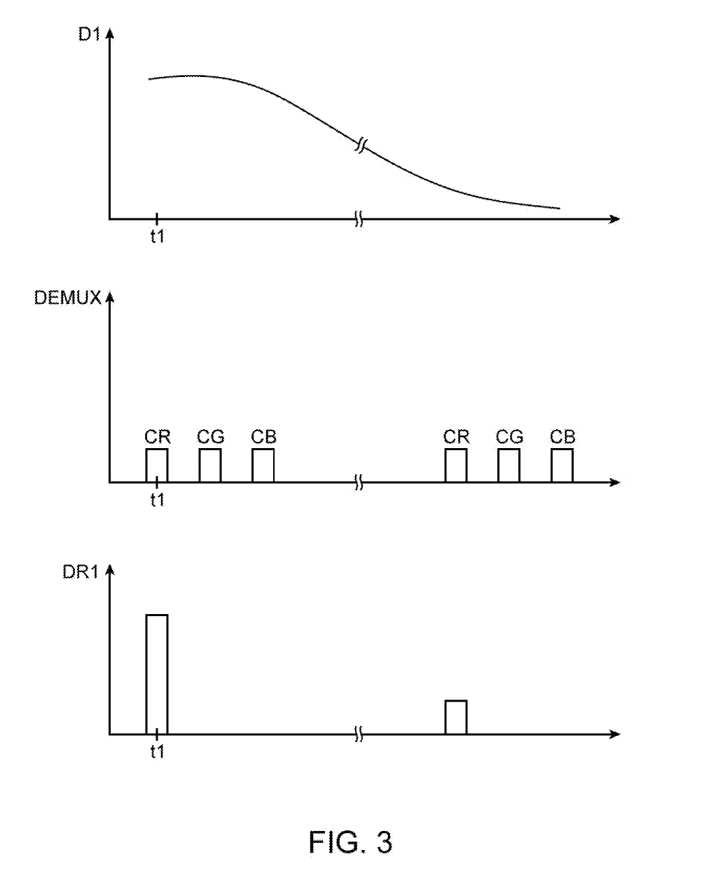

FIG. 3 is a graph showing how an illustrative data signal D1 (in the first column of pixel array 24) may be demultiplexed. The uppermost trace of FIG. 3 shows an illustrative data signal D1 on path 28. The middle trace of FIG. 3 shows how signals CR, CG, and CB may be asserted in sequence by display driver circuitry 22. As shown in the lowermost trace of FIG. 3, when red control signal CR is asserted, the current value of D1 (i.e., the value of D1 at time t1) is passed to line 30A and serves as signal DR1. Demultiplexing operations for the other color channels (i.e., the green and blue channels) are performed in the same way. Demultiplexing circuitry 26 may operate on a data signal Di on a path 28 in each column in pixel array 24, so as to produce a set of color-coded data signals DRi, DGi, and DBi on paths 30 in each column in the pixel array.

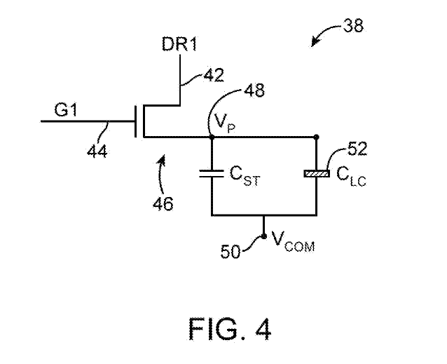

FIG. 4 is a circuit diagram of an illustrative display pixel in pixel array 24. In the example of FIG. 4, pixel 38 corresponds to a red pixel in the first column of pixel array 24. The blue and green pixels in the first column and the pixels in the other columns of array 24 may use the same type of circuitry.

Data signal DR1 may be supplied to terminal 42 from data line 30A (FIG. 2). Thin-film transistor 46 (e.g., a thin-film polysilicon transistor) may have a gate terminal such as gate 44 that receives gate line signal G1 from gate driver circuitry 40 (FIG. 1). When signal G1 is asserted, transistor 46 will be turned on and signal DR1 will be passed to node 48 as voltage Vp. Data for display 14 may be displayed in frames. Following assertion of signal G1 in one frame, signal G1 may be deasserted. Signal G1 may then be asserted to turn on transistor 46 and capture a new value of Vp in a subsequent display frame.

Pixel 38 may have a signal storage element such as capacitor Cst or other charge storage element. Storage capacitor Cst may be used to store signal Vp between frames (i.e., in the period of time between the assertion of successive signals G1).

Display 14 has a common electrode coupled to node 50. The common electrode (which is sometimes referred to as the Vcom electrode) may be used to distribute a common electrode voltage such as common electrode voltage Vcom to nodes such as node 50 in each pixel 38 of array 24. Capacitor Cst may be coupled between nodes 48 and 50. A parallel capacitance Clc arises across nodes 48 and 50 due to electrode structures in pixel 38 that are used in controlling the electric field through the liquid crystal material of the pixel. The electrode structures may be coupled to node 48. Capacitance Clc is associated with the capacitance between the electrode structures of pixel 38 that are coupled to node 48 and common electrode Vcom at node 50. During operation, the electrode structures at node 48 are used in applying a controlled electric field (i.e., a field having a magnitude proportional to Vp-Vcom) across a pixel-sized portion of liquid crystal material 52 in pixel 38. Due to the presence of storage capacitor Cst, the value of Vp (and therefore the associated electric field across liquid crystal material 52) is maintained across nodes 48 and 50 for the duration of the frame.

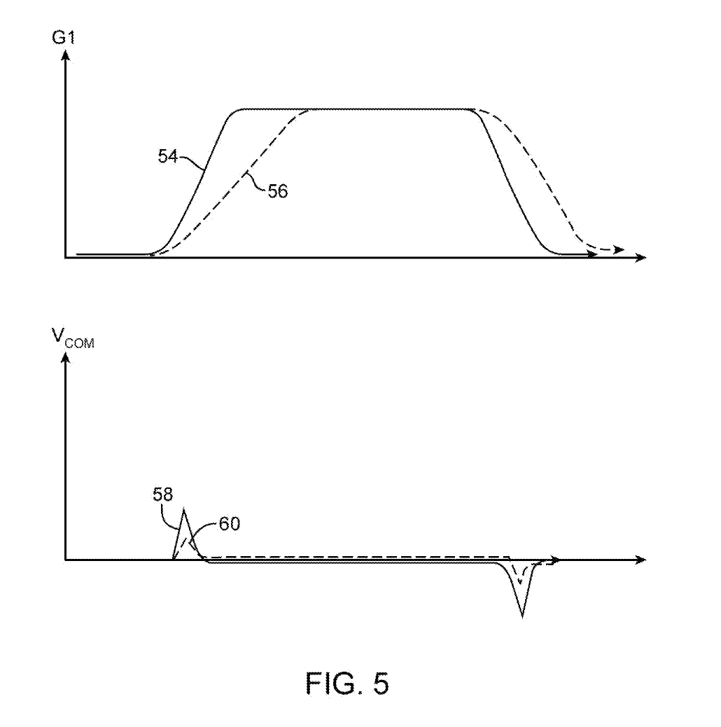

The presence of capacitances Cst and Clc can give rise to capacitive coupling between gate signal G1 and common electrode signal Vcom. During the leading and trailing edges of a gate signal pulse, this capacitive coupling may lead to perturbations in signal Vcom. The amount by which common electrode signal Vcom is perturbed by the gate line signal G1 depends on the length of the rise and fall times of signal G1. This effect is illustrated in the example of FIG. 5. Gate line signal G1 may be characterized by relatively fast rise and fall times (e.g., rise and fall times of about 1 microsecond), as illustrated by curve 54 in the upper graph of FIG. 5 or may be characterized by relatively slow rise and fall times (e.g., rise and fall times of about 2 microseconds), as illustrated by curve 56 in the upper graph of FIG. 5. As shown in the lower graph of FIG. 5, when gate signal G1 has relatively fast rise and fall times, Vcom will tend to be perturbed more (line 58) than when gate signal G1 has relatively slow rise and fall times (line 60).

Display 14 may have a single common electrode that produces a single common Vcom voltage for all of the pixels in the display. Alternatively, display 14 may be implemented using a segmented common electrode. In a segmented electrode design, the common electrode is patterned to form one or more discrete islands of conductive material (e.g., separate electrically isolated regions of indium tin oxide). Different sets of pixels are then coupled to different electrically isolated common electrode regions.

A segmented common electrode may, for example, be used in a display layout in which the common electrode traces are used to perform both common electrode functions for a liquid crystal display and touch sensor electrode functions for providing the display with touch capabilities.

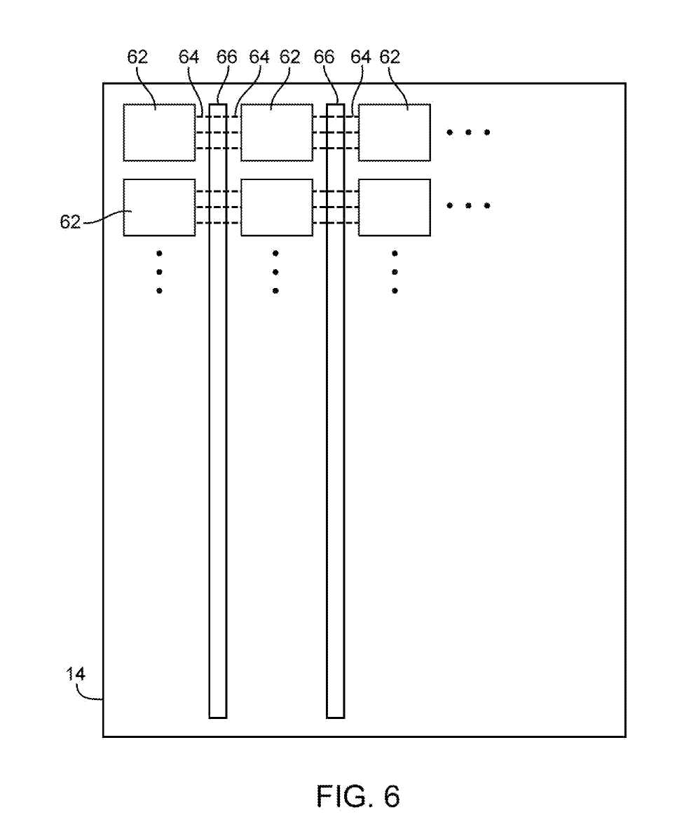

FIG. 6 is a top view of an illustrative segmented common electrode pattern of the type that may be used for display 14 in a configuration in which display 14 uses the segmented electrode regions of the common electrode to form capacitive touch sensor electrodes to provide display 14 with touch sensing capabilities. As shown in FIG. 6, display 14 may include rows of electrodes such as rectangular electrode pads 62. The rectangular electrode pads 62 in each row may be shorted together with other pads 62 in the row using horizontal electrical connections 64. In this way, the electrode structures of each row may be shorted together to form an electrode that spans the entire width of display 14 to form row-wide electrodes. Column-shaped electrodes such as electrodes 64 may be interposed between respective columns of pads 62. With this type of arrangement, a capacitive touch sensor array may be implemented for display 14 that has the ability to determine the position of a user's finger or other external object that has contacted the surface of display 14. For example, the horizontal position of a touch event may be determined using column electrodes 66 and the vertical position of the touch event may be determined using row electrodes formed by respective rows of pads 62.

In a display in which the common electrode (Vcom electrode) is segmented to form touch sensor electrode patterns (e.g., row and column touch sensor electrodes), perturbations in the magnitude of the common electrode voltage due to gate line signal transitions may vary between different electrode portions. This is because different common electrode regions (e.g., the rows and column regions of FIG. 6) may have different loading (“RC”) characteristics and may therefor give rise to different respective perturbations in signal Vcom. In a display of the type shown in FIG. 6, for example, gate line signal transitions may produce Vcom perturbations that have a first magnitude on row-shaped portions of the common electrode (e.g., row-shaped conductive regions formed from pads 62) and that have a second magnitude on column electrodes 64. As a result of these unequally sized Vcom perturbations, the pixels of display 14 that overlap column electrodes 64 may have a different brightness level than the pixels of display 14 that overlap row electrodes 62 (i.e., an undesirable set of parallel vertical columns may appear on the display).

Display artifacts such as these may be minimized or eliminated by adjusting the rise and fall times associated with the gate line signals so that they are as long as possible. When the rise and fall times are relatively long, the common electrode voltage Vcom may be perturbed by a relatively small amount, as illustrated by curve 60 in FIG. 5. Although the use of longer rise and fall times for the gate line signals may help reduce visible artifacts due to common electrode voltage perturbations, the use of excessively long rise and fall times should be avoided. If the gate line rise and fall times are too long, the transistors 46 in the pixels 38 of consecutive gate lines in display 14 might be turned on simultaneously, leading to the display of erroneous information and potentially visible horizontal artifacts.

By characterizing the performance of display 14 during manufacturing, an optimum set of gate line signal rise and fall times may be determined. Display 14 may then be calibrated so that the optimum rise and fall times are used. For example, test equipment may load adjustment settings into device 10 that direct the driver circuitry in the display to produce gate line signals with the appropriate optimum rise and fall times.

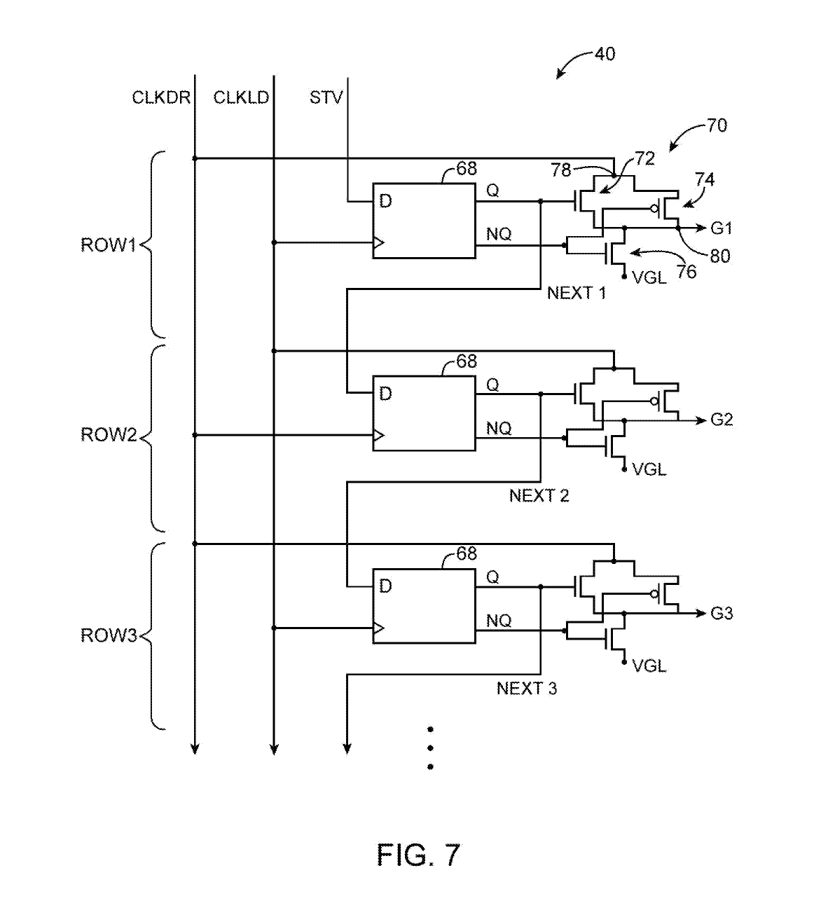

Illustrative gate driver circuitry 40 that may be used in providing display 14 with adjustable gate line signal rise and fall times is shown in FIG. 7. Three rows of gate line driver circuitry are shown in FIG. 7 (for row1, row2, and row2). The gate line driver circuitry in row1 is used in producing gate line signal G1. The driver circuitry of row2 and row3 is used in producing gate line signals G2 and G3, respectively.

Gate line driver circuitry 40 may include a column of register circuitry such as latches 68 (sometimes referred to as DQ flip-flops or edge-triggered flip-flops). Each latch is located in a respective row of the display and is used in supporting display control operations in that row.

The latch in each row of gate line driver circuitry 40 may have a true output Q that is coupled to the input D of a latch in a succeeding row and may have a complement output NQ (carrying data that is complementary to the data on true output Q). The coupling of output Q to the input D of the latch in the next gate driver row causes the gate line signals to be asserted in succession (i.e., first G1 is asserted, then G2 is asserted, then G3 is asserted, etc.).

Signal STV may be provided to latch 68 in row1 to initiate the gate line signal assertion process. Once initiated, signals NEXT are used to propagate the gate line assertion in each row of circuitry 40 to the next. For example, the assertion of signal NEXT1 by latch 68 in row1 may be used to trigger the assertion of gate line G2 by the gate driver circuitry of row 2, the subsequent assertion of signal NEXT2 by latch 68 in row2 may be used to trigger the assertion of gate line G3 in row2, and so forth, so that all gate line signals in the rows of pixel array 24 are asserted. The same gate line signal pattern may then be repeated to display another frame of data on display 14.

The rise and fall times of the gate line signals may be adjusted by adjusting the rise and fall times of clock signals CLKDR and CLKLD. Clock signals CLKDR and CLKLD may be generated by programmable clock signal generation circuitry in display driver circuitry 22. By loading appropriate settings (e.g., control bits) into display driver circuitry 22 during calibration operations, the leading and trailing edge transition times (i.e., the rise and fall times) of clock signals CLKDR and CLKLD may be selected. The rise and fall times may, for example, be set to values between 0.5 and 3 microseconds, may be set to values between 1.0 microseconds and 2 microseconds, or may be set to other suitable values.

The clock signals CLKDR and CLKLD are distributed to the clock inputs of latches 68. When a data input signal to a latch is held high (e.g., signal STV in row1 or NEXT1 . . . NEXT3 for subsequent rows), the next pair of clock signals that is received by a latch may be used in generating a corresponding output pulse. Latch output control signals such as these may be used in controlling output circuitry 70 in each row. The output circuitry 70 in each row may be used in gating clock signals.

As shown in row1 of FIG. 7, output circuitry 70 may include a pass gate for gating the clock signals. The pass gate may be, for example, a complementary metal-oxide-semiconductor (CMOS) pass gate formed from n-channel metal-oxide-semiconductor (NMOS) transistor 72 and p-channel metal-oxide-semiconductor (PMOS) transistor 74. The pass gate may be coupled between terminals 78 and 80. Terminal 78 may serve as an input to the pass gate and may receive a clock signal from display driver circuitry 22. Terminal 80 may serve as an output and may be used in supplying the clock signal to a gate line (e.g., gate line G1 in row1 of FIG. 7).

Output circuitry 70 may include a transistor such as transistor 76 to help pull down the voltage on node 80 to voltage VGL when the signal on gate line G1 is going low. As shown in FIG. 7, transistor 76 (e.g., an NMOS transistor) may be coupled between node 80 and a voltage source at voltage VGL (e.g., a ground voltage).

If desired, the pass gate between terminals 78 and 80 may be implemented using a single transistor (e.g., NMOS transistor 72 or PMOS transistor 74). The use of a CMOS pass gate in output circuitry 70, which is sometimes described herein as an example, may help reduce the need to apply over-driven control signals to the gate terminals of the pass gate and/or may help reduce or eliminate threshold-voltage-induced voltage drops for signals passing through the pass gate.

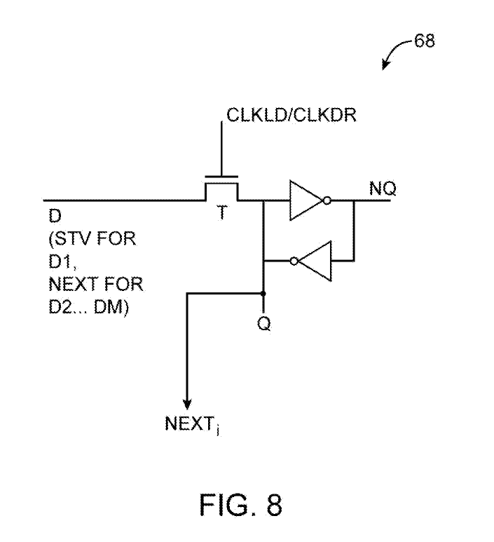

FIG. 8 shows circuitry that may be used in an illustrative embodiment of latch 68. Data input D may be used in receiving signal STV (in row1) and NEXT signals (in subsequent rows). Clock input CLKLD/CLKDR may be used in receiving clock signal CLKLD (in odd rows) and clock signal CLKDR (in even rows). A pair of cross-coupled inverters or that is coupled between true output Q and complement output NQ may be used in forming a bistable data storage element that latches data D when the clock signal on transistor T goes high.

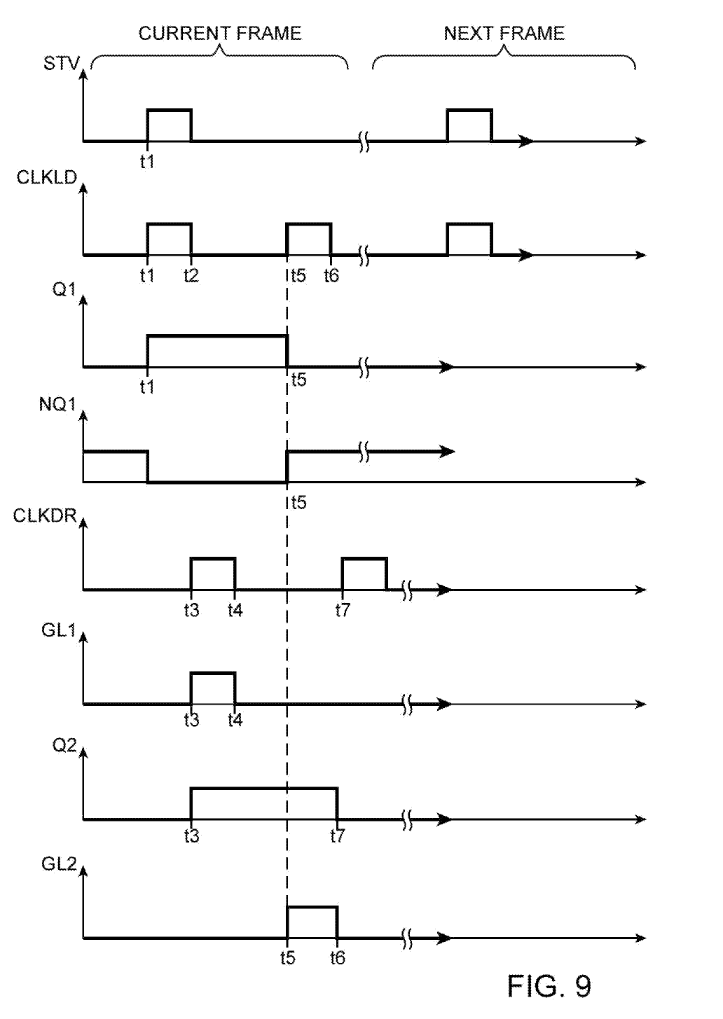

The way in which the circuitry of FIG. 7 uses signal STV and clock signals CLKLD and CLKDR to produce gate line signals is illustrated in FIG. 9.

As shown in the first trace of FIG. 9, signal STV may be asserted by display driver circuitry 22 at time t1. Display driver circuitry 22 may continuously produce clock signals such as a two-phase clock made up of clock signals CLKLD and CLKDR. As shown in the second trace of FIG. 9, clock signal CLKLD may have a rising edge at time t1 and a falling edge at time t2.

Signal STV is high at time t1. Because signal STV is presented to the data input D of latch 68 in row1, this input data is latched when clock signal CLKLD rises at time t1. The resulting rise in true output Q of latch 68 in row1 (i.e., true output Q1) at time t1 is shown in the third trace of FIG. 9. Complementary output NQ1 falls as output Q1 rises, as shown in the fourth trace of FIG. 9.

With Q1 high and NQ1 low at times after time t2, transistors 72 and 74 will be turned on (i.e., the pass gate in output circuitry 70 will be on and will be ready to allow signals to pass from node 78 to 80). Transistor 76 is off, so G1 is isolated from voltage VGL. In this configuration, signal CLKDR (i.e., the clock pulse that is presented to node 78 between times t3 and t4) is allowed to pass to node 80 and serves as gate line signal G1. The high value of Q1 and the corresponding low value of NQ1 serve as an enable signal that enables the pass gate in row1. With the pass gate enabled, signal CLKDR can pass to node 80 as signal G1. Signal G1 has a rising edge at time t3 and a falling edge at time t4, as shown in the sixth trace of FIG. 9 (i.e., GL1 is substantially the same as signal CLKDR). Subsequent clock signals CLKDR (i.e., clock signals after time t5) are blocked from reaching node 80 because at time t5 the low value of STV and the rising edge of clock CLKLD causes Q to go low and causes NQ to go high, thereby turning off the pass gate and turning on transistor 76 to pull G1 low (e.g., to ground voltage VGL).

Signal Q1 serves as signal NEXT1 of FIG. 7. At time t3, Q1 (NEXT1) is high at the data input D of latch 68 in row2. When clock CLKDR rises at the clock input of latch 68 in row2, as shown in the fifth trace of FIG. 9, Q2 is taken high, as shown in the seventh trace of FIG. 9. Q2 remains high until time t7. At time t7, the next CLKDR pulse goes high, latching the low value of Q1 (NEXT1) that is present at the date input D of latch 68 in row2 at t7 and thereby taking Q2 low.

The high value of Q2 from time t3 to t4 (and the corresponding low value of complementary signal NQ2 at the output of latch 68 in row2) are used to enable the pass gate at the output of latch 68 in row2. As a result, signal CLKLD (which rises at t5 and falls at t6) passes through the row2 pass gate and serves as gate line signal G2, as shown in the eighth trace of FIG. 9.

The process illustrated in FIG. 9 continues for all rows in pixel array 24 and repeats continuously so that multiple frames of data may be displayed on display 14.

Using circuitry of the type shown in FIG. 7, clock signals CLKDR and CLKLD are selectively allowed to pass through to the outputs of the gate driver circuitry in each row by selectively enabling and disabling the pass gates in the output circuitry of each row. The shape of the gate line signals that are produced by gate driver circuitry 40 and, in particular, the rise time and fall time of each gate line signal, is therefore determined by the rise time and fall time of the clock signals that are produced by display driver circuitry 22 and that are presented to the inputs of the pass gates.

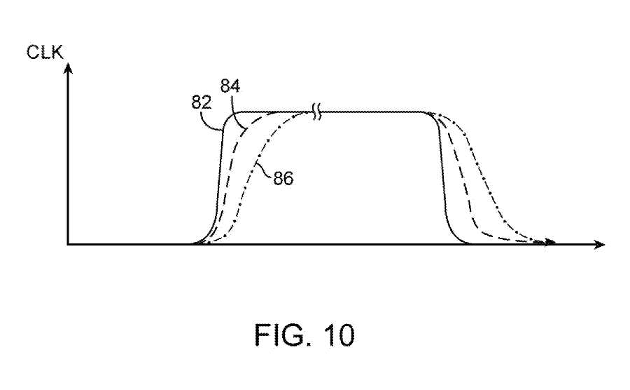

Display driver circuitry 22 (e.g., a commercially available driver IC) may be used to provide clock signals CLKDR and CLKLD with programmable rise and fall times. As shown in FIG. 10, the clock signal outputs CLK of driver IC 22 (which serve as gate line signals G1 . . . GM) may be adjusted to exhibit relatively short transition times (rise and fall times) as shown by curve 82, may be adjusted to exhibit relatively long transition times (rise and fall times) as shown by curve 86, or may be adjusted to have any of potentially numerous different intermediate transition times (rise and fall times) as indicated by curve 84. Rise and fall times may, if desired, be adjusted independently. The rise and fall times that may be selected using display driver circuitry 22 may, for example, be set to values between 0.5 and 3 microseconds, may be set to values between 1.0 microseconds and 2 microseconds, or may be set to other suitable values. Display driver circuitry 22 may be used to produce clock signals with five or more selectable transition time values, with ten or more selectable transition time values, or with any other suitable number of transition time values.

Each display 14 and therefore each device 10 that is provided with a display may exhibit slightly different performance characteristics due to manufacturing variations. To compensate for these variations (e.g., to avoid visible display artifacts on a display with a segmented common electrode), each display panel and/or device that contains a display may be characterized during testing and provided with appropriate compensating settings. The compensating settings may include, for example, settings that direct driver integrated circuit 22 to supply clock signals with particular rise and fall times. By adjusting the rise and fall times of the clock signals in this way, the rise and fall times of the gate line signals for a display may be adjusted to minimize visible display artifacts without allowing multiple gate lines to become simultaneously active.

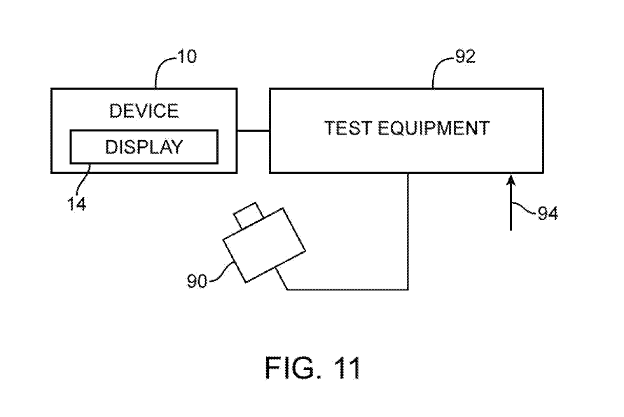

FIG. 11 shows equipment that may be used in making device characterizations during manufacturing. As shown in FIG. 11, a device such as device 10 may be manufactured with a display such as display 14. Display 14 may be characterized prior to assembly into device 10 or after assembly into device 10. The equipment that is used in characterizing display 14 may include visual inspection equipment such as camera 90. Camera 90 may be used to inspect display 14 while display 14 is displaying test patterns. Camera 90 may be used to capture images that are processed using test equipment 92.

Test equipment 92 may include one or more computers, one or more dedicated image processors, or other computing equipment for automatically analyzing captured test images from camera 90. Based on this analysis, the computing equipment of test equipment 92 may produce settings for use with device 10 and display 14. For example, if visible vertical lines are detected on display 14, test equipment 92 can generate settings for driver integrated circuit 22 that direct driver integrated circuit 22 to produce clock signals with longer rise and fall times. If artifacts are detected that indicate that the clock signals have excessive rise and fall times (e.g., rise and fall times that are causing consecutive rows of pixels in display 14 to be turned on simultaneously), test equipment 92 can generate settings for driver integrated circuit 22 that direct driver integrated circuit 22 to produce clock signals with shorter rise and fall times. Test equipment 92 may be used in loading the appropriate settings into device 10, so that driver integrated circuit 22 may use these settings when display 14 is operated by an end user of device 10.

If desired, some of the characterizing and calibration operations that are performed when manufacturing device 10 and display 14 may be performed manually. For example, an operator may use camera 90 or other equipment to manually observe the image quality on display 14 while a test pattern is being displayed.

If image quality is satisfactory, the operator may supply appropriate input to test equipment 92 via user input (e.g., using a user input interface such as a keyboard, touch screen, or computer mouse). The operator input may indicate to test equipment 92 that image quality is satisfactory. In response to receiving this input, test equipment 92 may instruct device 10 to use appropriate settings (e.g., the settings for display driver integrated circuit 22 that are currently loaded into device 10 and that are producing satisfactory image quality on display 14).

In the event that image quality does not appear to be satisfactory to the operator, the operator may provide input via input interface 94 that directs test equipment 92 to load alterative settings (e.g., alternative driver IC settings corresponding to alternative clock signal rise and fall times). Once a satisfactory set of alternative settings has been identified and once these alternative settings have been stored in device 10, device 10 can be shipped to an end user.

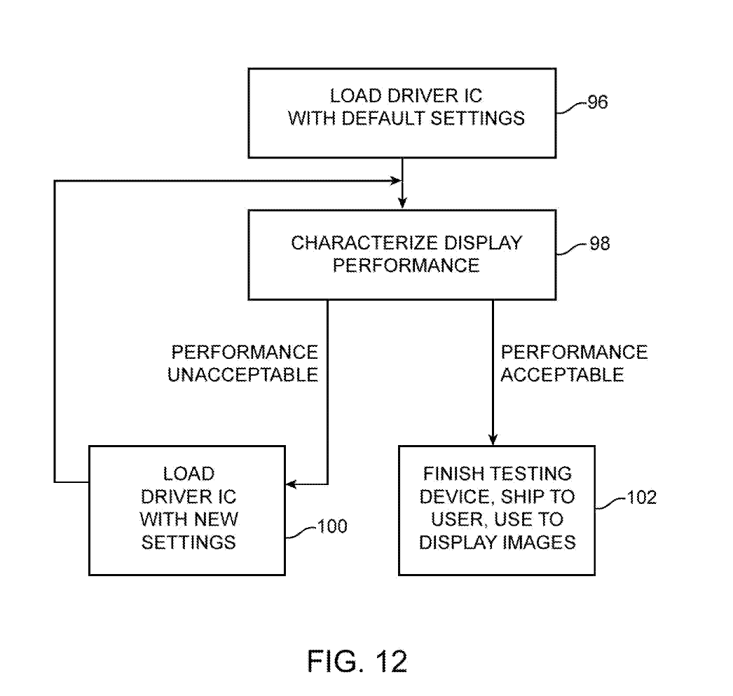

A flow chart of illustrative steps involved in characterizing and manufacturing devices 10 with displays 14 is shown in FIG. 12.

At step 96, equipment of the type shown in FIG. 11 or other suitable data loading equipment may be used to load default settings into a fully or partly assembled version of device 10 (e.g., display 14 including display driver circuitry 22 and optional additional components in device 10 such as circuitry 12). The default settings may include, for example a set of nominal clock signal rise and fall times settings for use by driver integrated circuit 22 in producing clock signals such as clock signals CLKDR and CLKLD.

At step 98, equipment of the type shown in FIG. 11 may be used in characterizing the performance of display 14. Automated and/or manual inspection techniques may be used, for example, to determine whether vertical lines corresponding to vertical Vcom segments are visible on the display while the display is displaying a test pattern or whether horizontal artifacts are present due to the undesired simultaneous activation of consecutive rows of pixels. If device performance is unsatisfactory, the equipment of FIG. 11 may be used to load different settings (step 100). For example, the equipment of FIG. 11 may be used to load settings for driver integrated circuit 22 that direct driver integrated circuit 22 to produce clock signals with longer rise and fall times in response to detection of vertical “Vcom” lines or may be used to load settings for driver integrated circuit 22 that direct driver integrated circuit 22 to produce clock signals with shorter rise and fall times in response to detection of horizontal artifacts that are indicative of the undesired simultaneous activation of pixels in consecutive rows.

Once performance has been characterized as being satisfactory during the operations of step 98, testing may be completed at step 102 (i.e., the optimum settings that have been identified may be retained in storage in control circuitry 18 and/or storage in driver integrated circuit 22) and device 10 may be shipped to an end user. The end user may use device 10 to display images on display 14. Because optimal settings for driver integrated circuit 22 have been loaded into device 10, the clock signals that are produced by driver integrated circuit 22 and therefore the gate line signals applied to display 14 will have satisfactory rise and fall times.

If desired, latching circuits other than the illustrative latching circuit of FIG. 8 may be used in gate driver circuitry 40. For example, latch 68 may include an inverter that inverts incoming (true) clock signals to produce inverted (complement) clock signals. The true and complement clock signals may then be used in controlling latch transistors within the latch. In designs of this type, there is a potential for non-negligible crossbar current to arise when switching the inverter (i.e., when the NMOS transistor and PMOS transistor of the inverter are each partly on), particularly when the speed of the clock signal has been slowed to produce a slow gate line signal. Inverter crossbar current can lead to undesirable power consumption and can potentially have an adverse impact on thin-film transistor reliability.

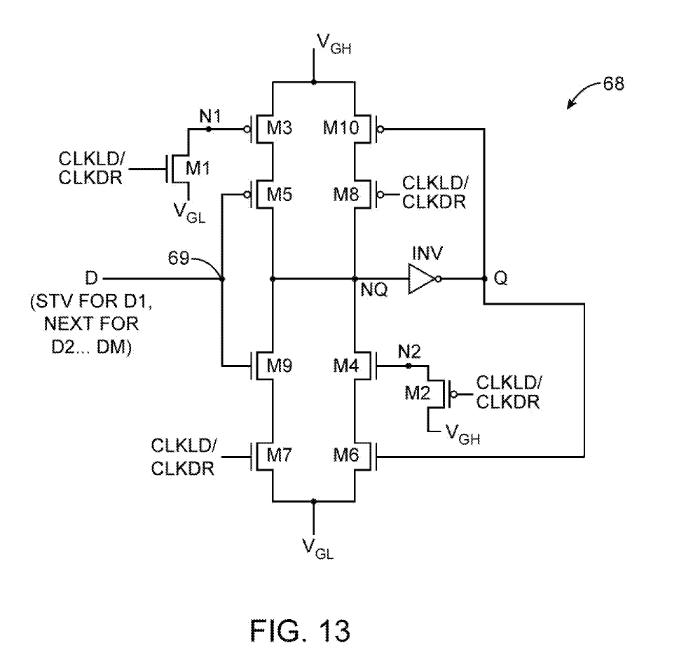

The potential for crossbar current can be eliminated using a latch circuit of the type shown in FIG. 13. As shown in FIG. 13, latch 68 may have a clock input (CLKLD/CLKDR). The clock input may receive clock signal CLKLD when latch 68 is used in odd rows of gate driver circuitry 40 and may receive clock signal CLKDR when latch 68 is used in even rows of gate driver circuitry 40.

Data D (i.e., signal STV for the first row of gate driver circuitry 40 or an appropriate NEXT signal for other rows) may be applied to data input node 69. Corresponding true and complement latch output signals may be provided at true output Q and complement output NQ.

The transistors of latch 68 of FIG. 13 may, as with other transistors in gate driver circuitry 40, be formed from thin-film transistors (e.g., polysilicon metal-oxide-semiconductor transistors implemented on a common substrate with the thin-film transistors used in pixel array 24). In addition to the transistors that form inverter INV, these thin-film transistors include latch transistors M1, M2, M3, M4, M5, M6, M7, M8, M9, and M10. Each transistor has a gate, a source, and a drain. The source and drain terminals of the transistors are sometimes collectively referred to as “source-drains.”

Transistors M3, M5, M9, and M7 may be coupled in series between positive power supply terminal VGH and ground power supply terminal VGL to form a left branch of latch 68. Transistors M10, M8, M4, and M6 may be coupled in series between positive power supply terminal VGH and ground power supply terminal VGL to form a right branch of latch 68.

Transistors M1 and M2 may each have gates that receive the same clock signal (CLKLD/CLKDR). Transistor M1 may have a first source-drain terminal that is coupled to the gate of PMOS transistor M3 and a second source-drain terminal that is coupled to power supply terminal VGL. Transistor M2 may have source-drain terminals coupled between positive power supply terminal VGH and the gate of transistor M4.

The latch circuit of FIG. 13 prevents the flow of crossbar current, because there is never a logical state in which the upper portion of one branch of the latch circuit (e.g., the path formed by transistors M3 and M4) is conducting while the lower portion of the other branch of the latch circuit (e.g., the path formed by transistors M4 and M6) is simultaneously conducting.

Transistor M1 serves as a pull down transistor and transistor M2 serves as a pull up transistor. Transistor is a PMOS transistor, whereas transistor M2 is an NMOS transistor. As a result, transistor M2 is off whenever transistor M1 is on and vice versa. Transistor M1 is used to turn on transistor M3 when CLKLD/CLKDR is asserted (taken high). Transistor M2 is used to turn on transistor M4 when CLKLD/CLKDR is deasserted (taken low).

When the clock signal (CLKLD/CLKDR) is asserted, the gate of transistor M1 is taken high, M1 is turned on, and the gate of transistor M3 is taken low to VGL, turning on transistor M3. While the clock signal is asserted, the gate of transistor M2 will be high, so M2 will be off and node N2 will float, allowing transistor M4 to potentially be turned weakly on. When the clock signal (CLKLD/CLKDR) is deasserted, the gate of transistor M2 is taken low, M2 is turned on, and the gate of transistor M4 is taken high to VGH, turning on transistor M4. The gate of transistor M1 while the clock is being deasserted is low, so M1 is off and node N1 floats, allowing transistor M3 to potentially be turned weakly on.

Although it is possible for M3 and M4 to be turned partly on at the same time (a potential crossbar current condition), transistors M5 and M6 have complementary states and will therefore not both be on simultaneously. As a result, there is never a short circuit (crossbar-type) path through transistors M3, M5, M4, and M6 from VGH to VGL. Transistors M7 and M8 likewise have complementary states (M7 is on when M8 is off and vice versa), so there will also never be a short circuit path through transistors M10, M8, M9, and M7.

The signals in the latch timing diagram of FIG. 9 apply to the operation of latch circuit 68 of FIG. 13. The use of transistors M1 and M2 during operation of latch circuit 68 of FIG. 13 helps reduce undesired crossbar-type currents that might otherwise flow during slow clock pulses, and therefore may help reduce dynamic switching power and improve reliability for the thin-film transistors of gate driver circuitry 40.

Consider, as an example, a situation in which Q of latch 68 of FIG. 13 is high and NQ is low and in which D is held high while the clock signal (CLKLD/CLKDR) is asserted to take NQ high and thereby switch the state of the latch. Because D is high, transistor M9 is on. When the clock signal goes high, the gate of transistor M7 is taken high. This turns on transistor M7 and pulls NQ low through transistor M9. The low value of NQ at the input to inverter INV is inverted by inverter INV so that signal Q at the output of inverter INV is taken high and transistor M6 is turned on. If transistor M4 is weakly on, transistor M4 will help transistors M9 and M7 pull node NQ low. If transistor M3 is simultaneously weakly on, there is a potential for crossbar current to flow through M3 and M4 (transistors that might have otherwise been used in forming an inverter in a latch circuit that uses an inverter to invert a true clock signal to produce a complement clock signal). However, because D is high, the gate of PMOS transistor M5 is high and transistor M5 is off when transistor M6 is turned on. The off state of transistor M5 will prevent a short circuit path from developing through transistors M3 and M5 between terminal VGH and node NQ. There will therefore be no potential for crossbar current to flow through M3, M5, M4, and M6, even if transistors M3 an M4 are simultaneously on. The use of transistors M1 and M2 to apply the clock signal for the latch to the gates of transistors M3 and M4 can likewise eliminated potential crossbar current in other data loading scenarios (e.g., when NQ, Q, and D have different patterns of values).

The foregoing is merely illustrative of the principles of this invention and various modifications can be made by those skilled in the art without departing from the scope and spirit of the invention.

What is claimed is:

1. Driver circuitry for producing gate line signals that are applied to gate lines in a display, the driver circuitry comprising:
at least one clock path configured to carry clock signals with adjustable transition times;
a plurality of latches; and
a plurality of output circuits that receive the clock signals with adjustable transition times from the at least one clock path and that receive signals from the latches, wherein the plurality of latches and output circuits are organized in a plurality of rows and wherein the output circuit in each row supplies a received clock signal to a gate line in that row to serve as a gate line signal for that row.

2. The driver circuitry defined in claim 1 further comprising an adjustable display driver circuit configured to supply the clock signals with the adjustable transition times to the at least one clock path.

3. The driver circuitry defined in claim 1 wherein the output circuit in each row includes a pass gate.

4. The driver circuitry defined in claim 3 wherein the pass gate in each row has input configured to receive the clock signal that serves as the gate line signal in that row from the at least one clock path.

5. The driver circuitry defined in claim 4 wherein the pass gate in each row has an output coupled to the gate line in that row.

6. The driver circuitry defined in claim 5 wherein the pass gate in each row includes at least one metal-oxide-semiconductor transistor.

7. The driver circuitry defined in claim 5 wherein the pass gate in each row includes an n-channel metal-oxide-semiconductor transistor and a p-channel metal-oxide-semiconductor transistor.

8. The driver circuitry defined in claim 7 further comprising an additional n-channel metal-oxide-semiconductor transistor in each row that is coupled to the gate line.

9. The driver circuitry defined in claim 5 wherein the latch in each row has true and complement outputs and wherein the true output is coupled to a first transistor gate in the pass gate and wherein the complement output is coupled to a second transistor gate in the pass gate.

10. The driver circuitry defined in claim 9 wherein the pass gate includes an n-channel metal-oxide-semiconductor transistor and wherein the first transistor gate is a gate of the n-channel metal-oxide-semiconductor transistor.

11. The driver circuitry defined in claim 10 wherein the pass gate includes a p-channel metal-oxide-semiconductor transistor and wherein the second transistor gate is a gate of the p-channel metal-oxide-semiconductor transistor.

12. The driver circuitry defined in claim 11 wherein the true output of the latch in each row is coupled to a data input of the latch in a successive row.

13. The driver circuitry defined in claim 12 wherein the output circuit of each row includes an additional n-channel transistor that is coupled to the gate line in that row and that has a transistor gate and wherein the complement output in that row is coupled to the transistor gate.

14. The driver circuitry defined in claim 13 further comprising an adjustable display driver integrated circuit configured to supply the clock signals with the adjustable transition times to the at least one clock path, wherein the adjustable transition times include an adjustable clock signal rise time and an adjustable clock signal fall time.

15. A method, comprising:
with a display driver circuit in a display, receiving settings that adjust a clock signal transition time;
with the display driver circuit, providing clock signals with the adjusted clock signal transition time from the display driver circuit to gate driver circuitry; and
with the gate driver circuitry, using the clock signals with the adjusted clock signal transition time to produce gate line signals for the display that have the adjusted clock signal transition time.

16. The method defined in claim 15 wherein the display driver circuit comprises a display driver integrated circuit and wherein the gate driver circuitry comprises polysilicon transistors on a thin-film transistor substrate layer and wherein providing the clock signals with the adjusted clock signal transition time comprises supplying the clock signals with the adjusted clock signal transition time from the display driver integrated circuit to the polysilicon transistors.

17. The method defined in claim 16 further comprising:
inspecting the display for visual artifacts from common electrode signal perturbations; and
based on results from inspecting the display, adjusting the settings.

18. A display, comprising:
an array of display pixels configured to receive display image data on data lines and having thin-film transistors controlled by gate line signals on gate lines; and
display driver circuitry that produces clock signals with adjustable rise and fall times; and
gate driver circuitry that receives the clock signals from the display driver circuitry and provides them to the gate lines to serve as the gate line signals.

19. The display defined in claim 18 wherein the gate driver circuitry comprises pass gates, wherein each pass gate provides a respective one of the clock signals to a respective one of the gate lines.

20. The display defined in claim 19 wherein the gate driver circuitry comprises latches that provide control signals to the pass gates.

21. The display defined in claim 20 further comprising a common electrode conductor for distributing common electrode signals to the display pixels, wherein the common electrode is segmented to form multiple isolated regions of common electrode conductor that serve as respective touch sensor electrodes.

22. The display defined in claim 20 wherein the latches each comprise a plurality of latch transistors including a first latch transistor having a first gate and a second latch transistor having a second gate, each latch further comprising a third transistor having a third gate that receives a given one of the clock signals and a fourth transistor having a fourth gate that receives that given one of the clock signals, wherein the third transistor has source-drain terminals coupled between a positive power supply terminal and the first gate, and wherein the fourth transistor has source-drain terminals coupled between a ground power supply terminal and the second gate.
